(19) United States
(12) Patent Application Publication
(10) Pub. No.: US 2014/0129064 A1
(43) Pub. Date: May 8, 2014

(54) METHOD AND APPARATUS FOR CONTROLLING ASSISTED BRAKE OF GREEN VEHICLE

(71) Applicants: HYUNDAI MOTOR COMPANY, Seoul (KR); KIA MOTORS CORPORATION, Seoul (KR)

(72) Inventor: Young Hak Kim, Suwon (KR)

(73) Assignees: KIA MOTORS CORPORATION, Seoul (KR); HYUNDAI MOTOR COMPANY, Seoul (KR)

(21) Appl. No.: 13/799,073

(22) Filed: Mar. 13, 2013

(30) Foreign Application Priority Data
Nov. 7, 2012 (KR) 10-2012-0125304

(51) Int. Cl. B60L 7/18

(52) U.S. Cl. CPC B60L 7/18
USPC 701/22

(57) ABSTRACT

Disclosed herein are a method and apparatus for controlling the assisted brake of a vehicle. The method includes initiating an assisted braking logic of a vehicle, calculating a weight of the vehicle, calculating a deceleration required for the vehicle, calculating a braking torque of a motor using the weight and the deceleration, and performing assisted braking functionality by controlling an inverter based on the braking torque.

### CROSS-REFERENCE

This application claims priority under 35 U.S.C. §119 to Korean Patent Application No. 10-2012- 0125304 filed on, Nov. 07, 2012, the disclosure of which is hereby incorporated by reference in its entirety.

### BACKGROUND OF THE INVENTION

1. Field of the Invention

The present invention relates to an apparatus and method for controlling the assisted brake of a green vehicle that enables assisted braking functionality via a motor to be performed in the green vehicle in accordance with the weight of the green vehicle.

2. Description of the Related Art

Recently, with the increasing concerns regarding environmental problems, green vehicles have become a popular alternative to conventional internal combustion engines. The term “green vehicles” refers to all vehicles that are driven by electric motors, such as hybrid vehicles, electric vehicles, and fuel cell vehicles. For green vehicles, assisted braking functionality (previously used in buses and commercial vehicles) can be performed using motors.

FIG. 1 is a flowchart showing a conventional method of controlling the assisted brake of a green vehicle. Referring to FIG. 1, once a user turns on an assisted brake switch at step S10 and the State of Charge (SOC) is equal to or less than 90% and the vehicle speed is equal to or less than a predetermined speed in step S20, an assisted brake is activated and then stable braking is supported at step S30.

In greater detail, the assisted braking functionality is configured to calculate required braking torque by substituting the current vehicle speed into a prepared data map and to control an inverter accordingly so that braking torque is then output via the motor at step S30. However, the braking torque in this method is controlled only depending on vehicle speed after a specific vehicle speed has been reached, so that actual assisted braking is not reliably achieved and assistant braking is not natural feeling.

That is, since the weight of a vehicle using an assisted brake, such as a bus or a commercial vehicle, varies dramatically depending on the number of passengers or the weight of freight, the conventional method in which braking torque is determined simply based on vehicle speed does not appropriately apply a braking force or alternatively an excessive braking force occurs.

### SUMMARY

Accordingly, the present invention has been made keeping in mind the above problems occurring in the prior art, and an object of the present invention is to provide an apparatus and method for controlling the assisted brake of a green vehicle, which operate an assisted brake after taking into consideration the weight of the vehicle, thereby achieving stable and natural control of the assisted brake.

In accordance with an aspect of the present invention, there is provided a method of controlling the assisted brake of a green vehicle, including initiating, by a controller, the assisted braking logic of a vehicle; calculating, by the controller, the weight of the vehicle; calculating, by the controller, deceleration required for the vehicle; calculating, by the controller, the braking torque of a motor using the weight and the deceleration; and performing, by the controller, assisted braking functionality by controlling an inverter based on the braking torque.

Initiating may be configured such that the assisted braking logic is entered when an assisted brake switch is turned on and a brake pedal and an accelerator pedal are not pressed. Calculating the weight may be configured so that the weight of the vehicle is calculated using a prepared data map that uses vehicle speed and output torque as input values and uses weight as an output value. Furthermore, calculating the deceleration may be configured so that the deceleration required for the vehicle is calculated using a prepared data map that uses a current vehicle speed of the vehicle as an input value and uses required deceleration as an output value.

Calculating the torque may include calculating a braking force using the weight and the deceleration and calculating the braking torque of the motor using the braking force. In addition, calculating the torque may include calculating the calculated braking force in terms of wheel torque using wheel radius and to calculate the wheel torque in terms of braking torque based on gear ratio. Furthermore, braking may include applying the braking torque required for the motor by controlling an inverter.

In accordance with another aspect of the present invention, there is provided an apparatus for controlling an assisted brake of a green vehicle, including an assisted brake switch configured to receive information about activation of assisted braking functionality; and a controller configured to, when the assisted brake switch is turned on, calculate current weight of the vehicle, calculate required deceleration based on current speed of the vehicle, calculate braking torque using the weight and the deceleration, and control an inverter so that the assisted braking functionality is performed via a motor.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart showing a conventional method of controlling the assisted brake of a green vehicle;

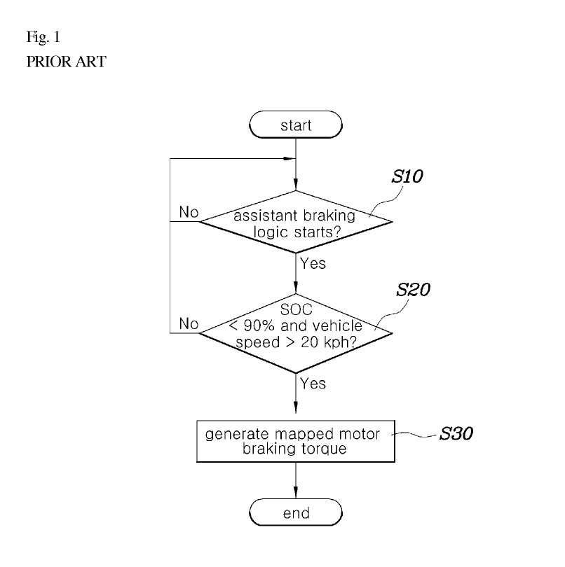

FIG. 2 is a flowchart of a method of controlling the assisted brake of a green vehicle in accordance with an exemplary embodiment of the present invention; and

FIG. 3 is a diagram showing the configuration of an apparatus for controlling the assisted brake of a green vehicle in accordance with an exemplary embodiment of the present invention.

### DETAILED DESCRIPTION

An apparatus and method for controlling the assisted brake of a green vehicle in accordance with exemplary embodiments of the present invention will be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Additionally, it is understood that the below methods are executed by at least one controller. The term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

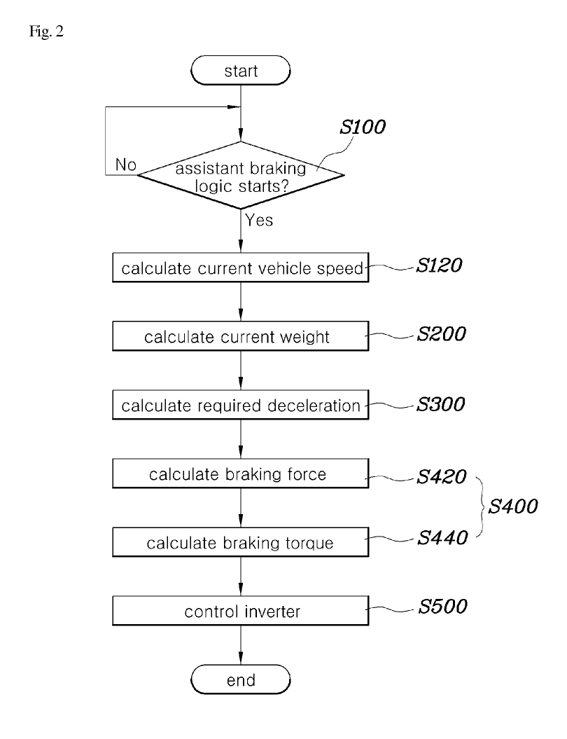

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. FIG. 2 is a flowchart of a method of controlling the assisted brake of a green vehicle in accordance with an exemplary embodiment of the present invention. The method of controlling the assisted brake of a green vehicle in accordance with this exemplary embodiment of the present invention includes an initiation step S100 of initiating the assisted braking logic of a vehicle by a controller, weight calculation step S200 of calculating the weight of the vehicle by the controller, deceleration calculation step S300 of calculating deceleration required for the vehicle by the controller, torque calculation step S400 of calculating the braking torque of a motor using the weight and the deceleration of the controller, and braking step S500 of performing assisted braking functionality by controlling an inverter based on the braking torque.

In the method of controlling the assisted brake of a green vehicle according to this exemplary embodiment of the present invention, initiation step S100 of initiating the assisted braking logic of the vehicle is performed. The assisted brake refers to an auxiliary brake that works only when necessary. Initiation step S100 is configured so that the assisted braking logic is initiated when an assisted brake switch is turned on and a brake pedal and an accelerator pedal are not pressed. Thereafter, the weight calculation step S200 for calculating the weight of the vehicle is performed. The weight of the vehicle may be calculated by measuring the weight of freight using a physical weight sensor and adding an unloaded (or empty) vehicle weight to the weight of the freight.

Alternatively, at weight calculation step S200, the weight of the vehicle may be calculated using a prepared data map that uses vehicle speed and output torque as input values and uses weight as an output value. This data map may be a data set that is prepared via experiments such that the weight can be obtained as an output value when the vehicle speed and the output torque are input as input values. Accordingly, using the data map, actual weight can be estimated in real time when actually measured vehicle speed and output torque are known. Thereafter, deceleration calculation step S300 of calculating deceleration required for the vehicle is performed. The deceleration required for the vehicle is the deceleration that can consume kinetic energy that is currently generated in the vehicle. During the deceleration calculation step S300, the deceleration required for the vehicle may be calculated using a prepared data map that uses the current vehicle speed of the vehicle as an input value and uses required deceleration as an output value.

This data map may be a data set that is prepared so that the required deceleration can be output when the vehicle speed is entered. Using this data map, the deceleration can be estimated in real time when the vehicle speed is known.

Furthermore, torque calculation step S400 of calculating the braking torque of the motor using the weight and the deceleration is performed. Braking force is obtained by calculating the real-time weight of the vehicle, obtaining the required deceleration in real time, and multiplying the weight and the deceleration by each other.

During torque calculation step S400, the braking force is calculated using the weight and the deceleration, and the braking torque of the motor is calculated using the braking force. More specifically, during the torque calculation step S400, the calculated braking force is calculated in terms of wheel torque using wheel radius, and the wheel torque is calculated in terms of braking torque based on gear ratio. That is, the calculated braking force is converted into torque by multiplying the calculated braking force by the wheel radius, and the resulting torque is converted into the braking torque required for the motor based on the gear ratio.

Finally, braking step S500 of performing assisted braking functionality by controlling an inverter based on the braking torque is performed. The inverter enables the braking torque generated in the motor to be controlled in real time by adjusting assisted load by the required braking torque. The control of the braking torque using the inverter may be implemented by applying one of a variety of conventional technologies regarding the control of an inverter related to regenerative braking. That is, during the braking step S500, control is performed by controlling the inverter so that the braking torque required for the motor is applied.

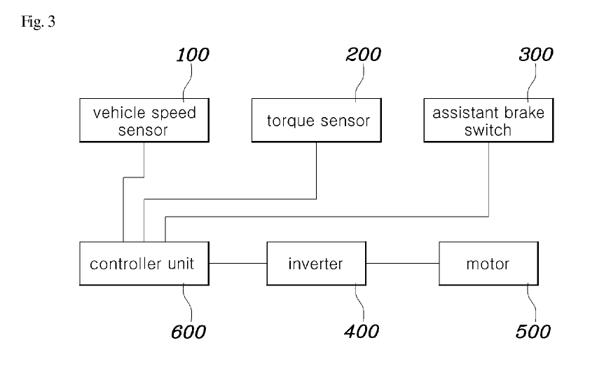

Meanwhile, an apparatus that controls the assisted brake of a green vehicle in order to perform the method of controlling the assisted brake of a green vehicle is shown in FIG. 3. FIG. 3 is a diagram showing the configuration of the apparatus for controlling the assisted brake of a green vehicle in accordance with an exemplary embodiment of the present invention.

The apparatus for controlling the assisted brake of a green vehicle in accordance with this exemplary embodiment of the present invention includes an assisted brake switch 300 configured to receive information about the activation of assisted braking functionality, and a controller 600 configured to, when the assisted brake switch 300 is turned on, calculate the current weight of the vehicle, calculate required deceleration based on the current speed of the vehicle, calculate braking torque using the weight and the deceleration, and control the inverter 400 so that the required assisted braking functionality is performed via the motor 500.

Furthermore, the controller 600 may be configured to estimate the weight of the vehicle using the vehicle speed input via a vehicle speed sensor 100 and the output torque sensed via a torque sensor 200 and calculate braking torque based on the weight, thereby obtaining the braking torque for which the weight has been taken into consideration.

In accordance with the above-described apparatus and method for controlling the assisted brake of a green vehicle, the assisted brake is operated after the weight of the vehicle has been taken into consideration, and therefore the control of the assisted brake of the green vehicle can be implemented in a stable and natural manner.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of controlling an assisted brake of a vehicle, comprising:
initiating, by a controller, an assisted braking logic of a vehicle;
calculating, by the controller, a weight of the vehicle;
calculating, by the controller, a deceleration required for the vehicle;
calculating, by the controller, a braking torque of a motor using the weight and the deceleration; and
performing, by the controller, assisted braking functionality by controlling an inverter based on the calculated braking torque.

2. The method of claim 1, wherein initiating the assisted braking logic further includes, initiating the assisted braking logic when an assisted brake switch is turned on and a brake pedal and an accelerator pedal are not pressed.

3. The method of claim 1, wherein calculating the weight of the vehicle further includes using a prepared data map that uses vehicle speed and output torque as input values and using weight as an output value.

4. The method of claim 1, wherein calculating the deceleration of the vehicle includes using a prepared data map that uses current vehicle speed of the vehicle as an input value and using required deceleration as an output value.

5. The method of claim 1, wherein calculating the torque includes calculating braking force using the weight and the deceleration and calculating the braking torque of the motor using the braking force.

6. The method of claim 5, wherein calculating the torque includes calculating the calculated braking force in terms of wheel torque using wheel radius and to calculate the wheel torque in terms of braking torque based on gear ratio.

7. The method of claim 1, wherein performing assisted braking functionality includes applying the braking torque required for the motor by controlling an inverter.

8. An apparatus for controlling assisted brake of a vehicle, comprising:
a switch configured to receive information regarding activation of assisted braking functionality; and
a controller configured to, when the assisted brake switch is turned on, calculate a current weight of the vehicle, calculate a required deceleration based on a current speed of the vehicle, calculate a braking torque using the weight and the deceleration, and control an inverter so that the assisted braking functionality is performed via a motor.

9. A non-transitory computer readable medium containing program instructions executed by a processor or controller, the computer readable medium comprising:
program instructions that initiate an assisted braking logic of a vehicle;
program instructions that calculate a weight of the vehicle;
program instructions that calculate a deceleration required for the vehicle;
program instructions that calculate a braking torque of a motor using the weight and the deceleration; and
program instructions that perform assisted braking functionality by controlling an inverter based on the calculated braking torque.
